(19) United States
(12) Patent Application Publication
(10) Pub. No.: US 2024/0119491 A1
(43) Pub. Date: Apr. 11, 2024

(54) RECOMMENDING VENDORS USING MACHINE LEARNING MODELS

(71) Applicant: INTUIT INC., Mountain View, CA (US)

(72) Inventors: Natalie BAR ELIYAHU, Azor (IL); Ido Joseph FARHI, Azor (IL)

(21) Appl. No.: 18/045,304

(22) Filed: Oct. 10, 2022

(51) Int. Cl. G06Q 30/0282; G06F 40/242; G06F 40/284; G06F 40/47; G06N 7/01

(52) U.S. Cl. CPC G06Q 30/0282; G06F 40/242; G06F 40/284; G06F 40/47; G06N 7/01

(57) ABSTRACT

The present disclosure provides techniques for recommending vendors using machine learning models. One example method includes receiving transaction data indicative of a transaction, generating one or more n-grams based on the transaction data, receiving a dictionary that comprises one or more lists of probability values comprising respective lists of probability values associated with the one or more n-grams, computing, for each respective vendor of the one or more vendors, a vendor probability value with respect to the transaction based on the one or more lists, and recommending a vendor for the transaction to a user based on the vendor probability value with respect to the transaction for each respective vendor of the one or more vendors.

### INTRODUCTION

Aspects of the present disclosure relate to recommending vendors using machine learning models.

Electronic transactions has become increasingly popular, particularly as more and more consumers utilize online purchases or online payment services. In many cases, electronic transaction records do not specify clear vendors.

To create records or references with respect to transactions, users (e.g., customers) often have to designate vendors for the electronic transaction records manually, which is time consuming, confusing at times, and prone to errors. In some cases, the electronic transaction records do not include enough information to help identify the vendor.

Some text-based recognition approaches can help identify some vendors from the electronic transaction records, but will fail when texts of the electronic transaction records and the vendors are completely unrelated phonetically and morphologically and/or are semantically different. For example, an electronic transaction record including the string “THANK YOU!” as the payee is related to a payment made to American Express®, but the string “THANK YOU!” alone does not make American Express obvious as the vendor. Thus, existing techniques that rely on direct text matching to identify vendors in transaction records will be unable to correctly identify the vendor for many transactions.

Accordingly, improved systems and methods are needed for determining vendors associated with transaction records.

### BRIEF SUMMARY

Certain embodiments provide a method for recommending vendors using machine learning models. The method generally includes receiving transaction data indicative of a transaction, generating one or more n-grams based on the transaction data, receiving a dictionary that comprises one or more lists of probability values comprising, for each respective n-gram of the one or more n-grams, a respective list of probability values associated with the respective n-gram, wherein the one or more lists are based on occurrences of the one or more n-grams in a plurality of historical transactions associated with one or more vendors, wherein each list of the one or more lists comprises a plurality of probability values, and wherein each probability value in each list of the one or more lists is associated with a respective vendor of the one or more vendors, computing, for each respective vendor of the one or more vendors, a vendor probability value with respect to the transaction based on the one or more lists, and recommending a vendor for the transaction to a user based on the vendor probability value with respect to the transaction for each respective vendor of the one or more vendors.

Another embodiment provides a system for recommending vendors using machine learning models. The system generally includes a memory including computer-executable instructions and a processor configured to execute the computer-executable instructions. Executing the computer executable-instructions causes the system to receive transaction data indicative of a transaction, generate one or more n-grams based on the transaction data, receive a dictionary that comprises one or more lists of probability values comprising, for each respective n-gram of the one or more n-grams, a respective list of probability values associated with the respective n-gram, wherein the one or more lists are based on occurrences of the one or more n-grams in a plurality of historical transactions associated with one or more vendors, wherein each list of the one or more lists comprises a plurality of probability values, and wherein each probability value in each list of the one or more lists is associated with a respective vendor of the one or more vendors, compute, for each respective vendor of the one or more vendors, a vendor probability value with respect to the transaction based on the one or more lists, and recommend a vendor for the transaction to a user based on the vendor probability value with respect to the transaction for each respective vendor of the one or more vendors.

Still another embodiment provides a non-transitory computer readable medium for recommending vendors using machine learning models. The non-transitory computer readable medium generally includes instructions to be executed in a computer system, wherein the instructions when executed in the computer system perform a method for recommending vendors using machine learning models on a computing device requiring minimal run time processing. The method generally includes receiving transaction data indicative of a transaction, generating one or more n-grams based on the transaction data, receiving a dictionary that comprises one or more lists of probability values comprising, for each respective n-gram of the one or more n-grams, a respective list of probability values associated with the respective n-gram, wherein the one or more lists are based on occurrences of the one or more n-grams in a plurality of historical transactions associated with one or more vendors, wherein each list of the one or more lists comprises a plurality of probability values, and wherein each probability value in each list of the one or more lists is associated with a respective vendor of the one or more vendors, computing, for each respective vendor of the one or more vendors, a vendor probability value with respect to the transaction based on the one or more lists, and recommending a vendor for the transaction to a user based on the vendor probability value with respect to the transaction for each respective vendor of the one or more vendors.

The following description and the related drawings set forth in detail certain illustrative features of the various embodiments.

### BRIEF DESCRIPTION OF DRAWINGS

The appended figures depict certain features of the various aspects described herein and are not to be considered limiting of the scope of this disclosure.

FIG. 1 depicts an example model trainer for training a machine learning model to recommend vendors.

FIG. 2 depicts an example predictive model for recommending vendors.

FIG. 3 depicts an example process for dictionary generation.

FIG. 4 depicts an example process for recommendation generation.

FIG. 5 is a flow diagram of example operations for recommending vendors using a machine learning model.

FIG. 6 depicts an example application server related to embodiments of the present disclosure.

### DETAILED DESCRIPTION

Aspects of the present disclosure provide apparatuses, methods, processing systems, and computer-readable mediums for recommending vendors using machine learning models.

While conventional computer-based techniques for determining vendors from electronic transaction records are generally based on text matching (e.g., comparing text from transaction records to names of known vendors), embodiments of the present disclosure utilize machine learning techniques to determine vendors that would not be recognized through text matching alone.

In some aspects, a machine learning model is used to predict a recommended vendor for a transaction to a user. The machine learning model can utilize natural language processing (NLP) techniques to process the data in an electronic transaction record for better understanding. NLP techniques can include tokenizing the input transaction data, removing generic tokens from the tokenized transaction data, and generating n-grams based on cleaned (e.g., without generic tokens) tokenized transaction data. N-grams are groups of up to n consecutive words, where n is a positive integer. Utilizing NLP techniques, including the use of n-grams as described herein, can allow for identifying a vendor for an electronic transaction even when a correlation is low between a vendor's name and the textual information in the electronic transaction record, such as when the electronic transaction record does not include enough information to help identify the vendor, or when texts of the electronic transaction record and the vendor are unrelated phonetically and morphologically and are even semantically different.

According to embodiments of the present disclosure, a machine learning model makes predictions based on n-grams rather than directly based on the textual transaction data, thus utilizing more granular inputs (e.g., as compared to larger amounts of text) in order to produce predictions that are more accurate. Often, a particular part of the transaction data is critical in determining a vendor for the transaction, whereas the remainder of the transaction data is largely irrelevant for identifying the vendor. N-grams can be used to separate parts of the transaction data that include important information for identifying the vendor from the remainder of the transaction data.

In some aspects, a machine learning model utilizes a set of pre-trained weights in making predictions. For example, the pre-trained weights can include conditional probabilities of respective vendors to be designated as the vendor in an arbitrary transaction given that a particular n-gram appeared in the arbitrary transaction. The machine learning model can predict a recommended vendor based on the pre-trained weights.

The pre-trained weights may be represented as a dictionary, whose keys are the n-grams and whose values are the conditional probabilities discussed above, where each n-gram is associated in the dictionary with a conditional probability for each vendor. In one example, the conditional probabilities are represented as a list.

The pre-trained weights may be generated in a training process. Historical transaction data with known vendors for each transaction in the historical transaction data can be used during the training process to generate the pre-trained weights. For example, a particular n-gram appearing in a large number of historical transaction records having a particular known vendor will have a larger pre-trained weight (e.g., conditional probability) for the particular known vendor than a different n-gram that appears in few or no historical transaction records having the particular known vendor.

In some aspects, the machine learning model uses fuzzy string matching (e.g., based on edit distance) between the recommended vendor and the transaction data to detect textual matches that are not necessarily identical.

Accordingly, by using n-grams in the particular manner described herein as granular inputs to a machine learning model, and by utilizing fuzzy matching in some cases, techniques described herein allow a computer to predict a recommended vendor with a higher level of accuracy than conventional computer-based techniques such as those based only on textual matching. The high accuracy can further help to save time, avoid unnecessarily utilization of computing resources (e.g., that would otherwise be utilized in relation to inaccurate predictions), reduce user confusion, and improve a user experience of software applications.

### Example Model Trainer for Recommending Vendors

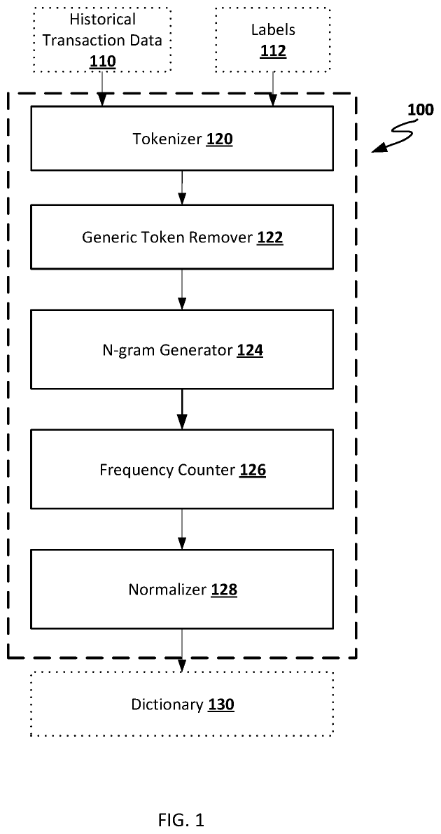

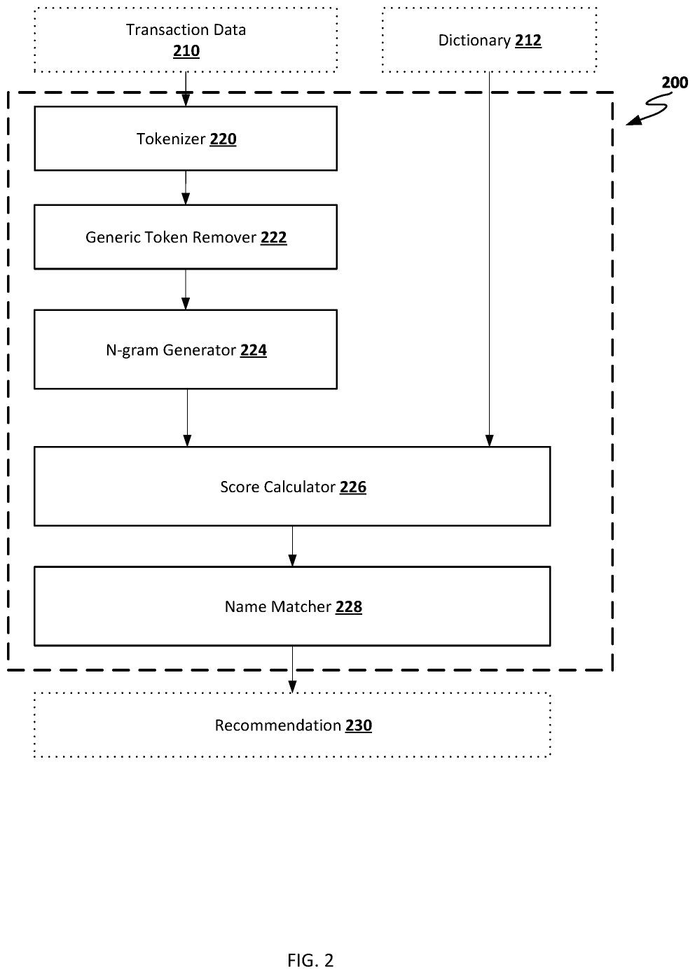

FIG. 1 depicts an example model trainer 100 for training a machine learning model to recommend vendors. Model trainer 100 receives historic transaction data 110 and labels 112 as inputs and generates dictionary 130 as the output. Historic transaction data 110 can indicate one or more transactions. Accordingly, labels 112 indicate the respective known vendors for the one or more transactions. The known vendors can be designated or verified by users. Historic transaction data 110 and labels 112 can be electronic data. Dictionary 130 can be regarded as a set of pre-trained weights for one or more machine learning models, as described in more detail below with respect to FIG. 2.

Historic transaction data 110 and labels 112 can be provided as inputs to tokenizer 120, and tokenizer 120 tokenizes each transaction of the one or more transactions. In some embodiments, tokenizer 120 tokenizes each instance of transaction data based on spaces (e.g. split by space), such that each token is a word. In some embodiments, tokenizer 120 can add a beginning of sentence (BOS) token at the beginning of each instance of transaction data and an end of sentence (EOS) token at the end of each instance of transaction data. Adding BOS and EOS tokens allows for identification of vendors based on whether tokens are adjacent to the beginning or end of a sentence (e.g., being in the same n-gram as a BOS or EOS token). Each tokenized transaction can be associated with a respective known vendor for the transaction, with known vendors for transactions being indicated in labels 112.

In some embodiments, tokenized transactions are provided as inputs to generic token remover 122 to remove generic tokens from tokenized transactions. Generic tokens can be words with frequent appearance in transactions but that do not convey much information about the vendor. For example, words such as “the”, “of”, “at”, or “a” can be generic tokens. Generic tokens can be removed from the tokenized transactions by generic token remover 122 based on statistics such as term frequency—inverse document frequency, also known as tf-idf. As discussed above, each tokenized transaction with generic tokens removed can be associated with a known vendor for the transaction in labels 112. For simplicity, tokenized transactions with generic tokens removed are also referred to as tokenized transactions in the following discussion.

Tokenized transactions from tokenizer 120 or generic token remover 122 can be provided as inputs to n-gram generator 124 to generate n-grams. Each n-gram can be associated with a respective known vendor. N-grams can have a maximum of n consecutive words in the tokenized transactions, where n is a positive integer. In some examples, if a tokenized transaction is a list of tokens, such as [“BOS”, “A”, “B”, “EOS”], and n=2, the n-grams include [“BOS”, “A”], [“A”, “B”], and [“B”, “EOS”]. When n=1, the n-grams are known as unigrams. In some embodiments, each n-gram includes a maximum of 3 words (e.g., n=3). In some examples, two distinct tokenized transactions associated with two distinct vendors can be used to generate the same n-gram.

N-grams can be provided as inputs to frequency counter 126 to compute frequencies associated with vendors. Frequency counter 126 can compute, for each n-gram, a frequency with which the n-gram is associated with a vendor. In some examples, each n-gram is associated with a set of frequencies corresponding to one or more distinct vendors.

The frequencies can be provided as inputs to normalizer 128 to generate lists of probability values. Each respective n-gram can be associated with a respective list of probability values, which represents the probabilities that distinct known vendors are associated with an n-gram. The probability values can be generated by normalizing, for each n-gram, the frequency with which the n-gram is associated with a vendor. In some embodiments, a total frequency of the associated vendor with respect to the n-grams is counted, and the frequency with which the n-gram is associated with the associated vendor is divided by the total frequency of the associated vendor with respect to all of the n-grams to generate the probability values. The lists of probability values can be regarded as conditional probabilities of respective vendors to be designated as the vendor for an arbitrary transaction given that the n-gram appeared in a record of the arbitrary transaction.

In addition, normalizer 128 can compile the lists of probability values based on the n-grams. For example, normalizer 128 can generate a dictionary based on the lists of probability values, where the keys of the dictionary can be the n-grams and the values corresponding to the keys can be the lists of probability values. In some embodiments, alternatively, the compiled lists of probability values are represented using other data structures, such as a matrix, a graph, a nested dictionary, or a pandas Dataframe.

Dictionary 130 represents a dictionary generated by normalizer 128, or the matrix, the graph, the nested dictionary, or the pandas Dataframe as discussed above. For simplicity, dictionary 130 is assumed to be the dictionary generated by normalizer 128. In general, dictionary 130 can be a set of weights learned through a training process as described herein.

### Example Predictive Model for Recommending Vendors

FIG. 2 depicts an example predictive model 200 for recommending vendors. Although illustrated as a Gaussian classifier, predictive model 200 can be any classifier, such as a logistic regression model, a support vector machine, a random forest, or a neural network.

Predictive model 200 receives as inputs transaction data 210 and dictionary 212 and generates recommendation 230 as output. In some embodiments, transaction data 210 is similar to historical transaction data 110 as shown in FIG. 1 but indicates one transaction (e.g., for which a vendor is not yet known). In some embodiments, dictionary 212 is dictionary 130 as shown in FIG. 1, which includes one or more lists of probability values comprising, for each respective n-gram of one or more n-grams, a respective list of probability values associated with the respective n-gram, the one or more lists being based on occurrences of the one or more n-grams in a plurality of historical transactions associated with one or more vendors. In an example, each list of the one or more lists comprises a plurality of probability values, and each probability value in each list of the one or more lists is associated with a respective vendor of the one or more vendors. Similar to dictionary 130, each list of probability values in dictionary 212 can be a list of conditional probabilities of respective vendors to be designated as the vendor in an arbitrary transaction given that an n-gram appeared in the arbitrary transaction. In some embodiments, alternatively or additionally, dictionary 212 includes a set of pre-trained weights for predictive model 200 (e.g., the conditional probabilities may be the pre-trained weights).

Transaction data 210 can be provided to tokenizer 220 to generate a tokenized transaction. In some embodiments, tokenizer 220 is similar to tokenizer 120 as shown in FIG. 1. Tokenizer 220 can tokenize a transaction. In some embodiments, tokenizer 220 tokenizes the transaction data by space (e.g. split by space), such that each token is a word. In some embodiments, tokenizer 220 can add a beginning of sentence (BOS) token at the beginning of the transaction data and an end of sentence (EOS) token at the end of the transaction data.

In some embodiments, the tokenized transaction is provided as one or more inputs to generic token remover 222 to remove generic tokens from the tokenized transaction. In some embodiments, generic token remover 222 is similar to generic token remover 122 as shown in FIG. 1. Generic tokens can be removed from the tokenized transaction by generic token remover 222 as discussed above. For simplicity, the tokenized transaction with generic tokens removed is also referred to as the tokenized transaction in the following discussion.

The tokenized transaction from tokenizer 220 or generic token remover 222 can be provided as one or more inputs to n-gram generator 224 to generate n-grams. In some embodiments, n-gram generator 224 is similar to n-gram generator 124 as shown in FIG. 1. In some embodiments, each n-gram includes a maximum of 3 words (e.g., n=3).

N-grams and dictionary 212 can be provided as inputs to score calculator 226 to compute, for each respective vendor of the one or more vendors, a vendor probability value with respect to the transaction based on the one or more lists of probability values in dictionary 212. In some embodiments, score calculator 226 sums probability values in the one or more lists of probability values associated with each n-gram of the n-grams, wherein the probability values are associated with the vendor. In addition, based on the probability values of the one or more vendors, score calculator 226 can generate a recommended vendor based on the vendor with the maximum probability value.

The recommended vendor can be provided as input to name matcher 228. Name matcher 228 can designate the recommended vendor as recommendation 230 if the recommended vendor is indicated in transaction data 210. Otherwise, name matcher 228 can use fuzzy string matching (e.g., based on the edit distance) between the recommended vendor and transaction data 210, and still designate the recommended vendor as recommendation 230 even if there is no direct match. If no fuzzy string matching has been found between the recommended vendor and transaction data 210, name matcher 228 can request a next recommended vendor based on the vendor with the next maximum probability value from score calculator 226, and determine if the next recommended vendor can be designated as recommendation 230 following the criteria discussed above. In alternative embodiments, the vendor with the highest probability value is designated as recommendation 230 regardless of whether the vendor name is identified in the transaction data or whether fuzzy string matching results in an identified match.

Recommendation 230 can be provided to a user associated with transaction data 110. The user can accept recommendation 230 as the vendor or reject recommendation 230 and designate a vendor. The user's acceptance or new designation can be used as labels for future training of predictive model 200, for example, through model trainer 100 as shown in FIG. 1. Thus, embodiments of the present disclosure provide a feedback loop by which the machine learning model is continuously improved based on user feedback, resulting in improved predictions.

In some embodiments, in addition to dictionary 212, a local dictionary (not illustrated) local to the user associated with transaction data 210 is generated based on the historic transaction data local to the user. In such embodiments, name matcher 228 can determine a matching between the recommended vendor and the vendors in the local dictionary. In such embodiments, alternatively or additionally, dictionary 212 is used as a Bayesian prior in predictive model 200, and score calculator 226 also utilizes the local dictionary to generate the recommended vendor.

### Example Process for Dictionary Generation

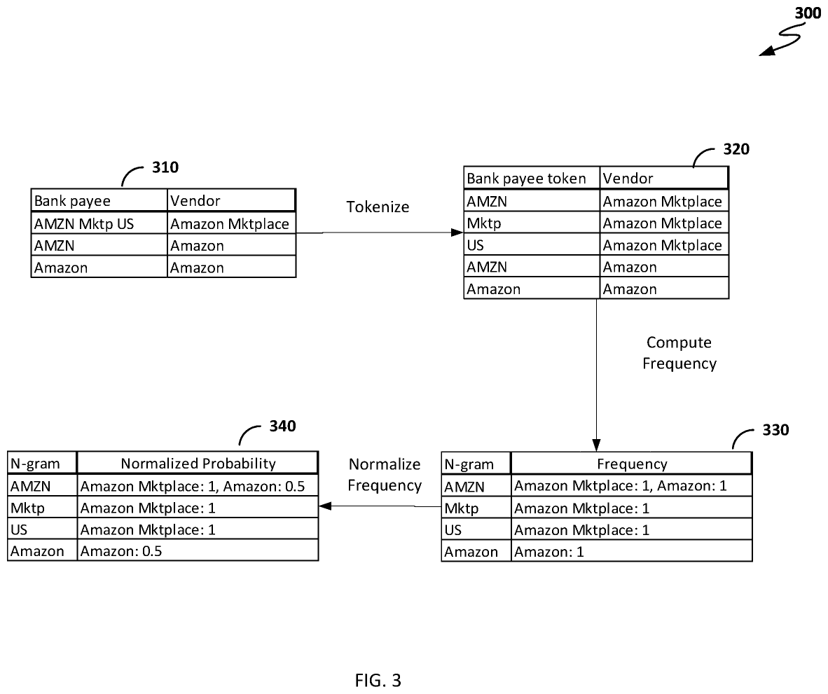

FIG. 3 depicts an example process 300 for dictionary generation. The dictionary generated can be dictionary 130 as shown in FIG. 1. Process 300 can be carried out by a model trainer, such as model trainer 100 as shown in FIG. 1. Although process 300 is depicted for dictionary generation, process 300 can be used to generate a set of pre-trained weights for machine learning models, as discussed above. In addition, though the example uses specific company names and abbreviations, such as “Amazon®” and “AMZN”, process 300 can be applied to transaction data associated with any company.

Process 300 can take as inputs training transaction data 310. Although depicted as tabular data, training transaction data 310 can be represented in other data structures, such as a list or a dictionary. Training transaction data 310 can include labels, such as known vendors for the respective transactions. Training transaction data 310 can be historic transaction data 110, or a subset of historic transaction data 110, combined with labels 112 as discussed with respect to FIG. 1. As depicted, training transaction data 310 can include entries of labeled data (e.g., with known vendors) for several transactions. Each transaction in training transaction data 310 can represent a bank payee. Each of the bank payees in training transaction data 310 can be associated with a vendor. For example, as depicted, bank payee “AMZN Mktp US” is associated with vendor “Amazon Mktplace”.

Process 300 can tokenize training transaction data 310 into tokenized training transaction data 320 to generate n-grams. Tokenized training transaction data 320 can be generated by tokenizer 120, and optionally, cleaned (e.g., with generic tokens removed) by generic token remover 122 as discussed with respect to FIG. 1. For example, tokens are generated by splitting each transaction (e.g., including the text of each bank payee as indicated in the transaction record) in training transaction data 320 by spaces. The tokens are associated with the label (e.g., the vendor) for the transaction. For example, the bank payee text “AMZN Mktp US” can be split into three bank payee tokens, namely “AMZN”, “Mktp”, and “US”. In addition, all of the three bank payee tokens “AMZN”, “Mktp”, and “US” are associated with the vendor “Amazon Mktplace,” which is the known vendor associated with these tokens in the transaction record. In this example, with n=1 for the n-grams, the tokens are recognized (e.g. by n-gram generator 124 as shown in FIG. 1) as unigrams (e.g., n-grams with n=1), but other positive integer values for n are possible.

Process 300 can compute frequencies for the vendor associated with each n-gram of the n-grams generated (e.g., by frequency counter 126 as shown in FIG. 1). For example, the n-gram “AMZN” can be associated once with vendor “Amazon Mktplace” (e.g., based on the second row of tokenized training transaction data 320) and once with vendor “Amazon” (e.g., based on the fifth row of tokenized training transaction data 320). Accordingly, in this example, the n-gram “AMZN” can correspond to a list (or a dictionary) of frequencies [Amazon Mktplace: 1, Amazon: 1], where each element in the list of frequencies represents a frequency that the associated vendor appears with the n-gram.

Process 300 can normalize frequencies for the vendor associated with each n-gram to generate lists of probability values, based on the total frequency of the vendor (e.g., by normalizer 128 as shown in FIG. 1). In this example, the vendor “Amazon” occurs twice in training transaction data 310, and thus has a total frequency of 2. Accordingly, the frequency for the vendor “Amazon” in the lists can be normalized by dividing the frequency by the total frequency of the vendor “Amazon” (e.g., 2). As a result, the normalized probability for the vendor “Amazon” in the list associated with the n-gram “AMZN” can be 0.5.

Process 300 can compile lists of probability values associated with the n-grams as dictionary 340. For example, dictionary 340 can be an example dictionary 130 as shown FIG. 1. In some embodiments, dictionary 340 can be represented using other data structures, such as a matrix, a graph, a nested dictionary, or a pandas Dataframe, as discussed above.

### Example Process for Recommendation Generation

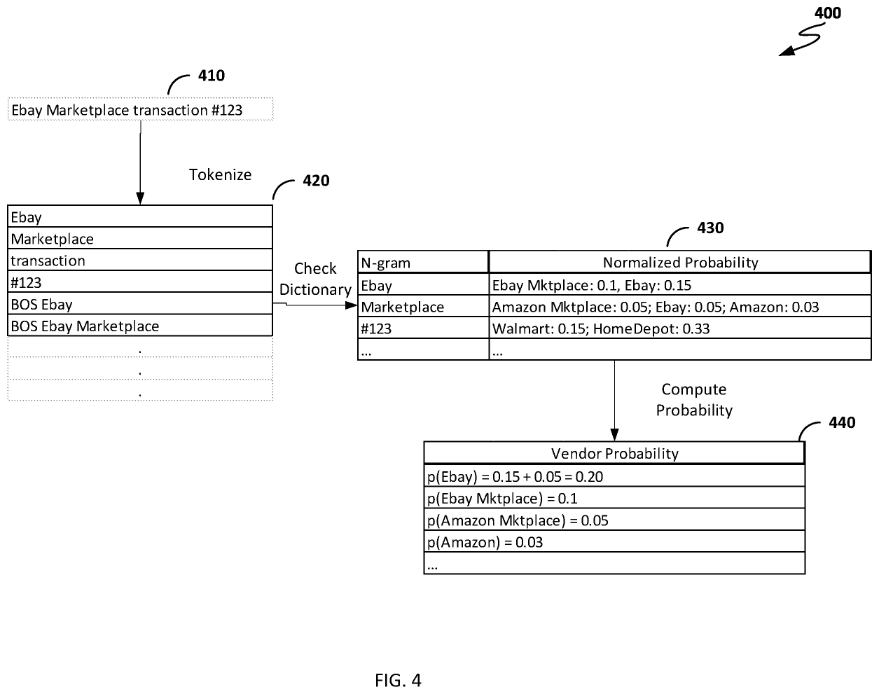

FIG. 4 depicts an example process 400 for recommendation generation. The recommendation generated can be recommendation 230 as shown in FIG. 2. Process 400 can be carried out by a predictive model, such as predictive model 200 as shown in FIG. 2. Although the example uses specific company names and abbreviations, such as “Amazon” and “AMZN”, process 400 can be applied to transaction data associated with any company.

Process 400 can take as inputs transaction data 410. Although depicted as a string, transaction data 410 can be represented using other data structures, such as a list. As depicted, transaction data 410 can include an entry of transaction data. Transaction data 410 can be generated by combining (e.g. concatenating) text information in a transaction, such as a bank payee and a comment. In this example, transaction data 410 is a string “Ebay Marketplace transaction #123”.

Process 400 can tokenize transaction data 410 to generate n-grams 420. Transaction data 410 can be tokenized by tokenizer 220, and optionally, cleaned (e.g., with generic tokens removed) by generic token remover 222 as discussed with respect to FIG. 2. For example, tokens are generated by splitting transaction data 410 by spaces. In addition, a beginning of sentence (BOS) token can be added at the beginning of transaction data 410 and an end of sentence (EOS) token can be added at the end of transaction data 410. In this example, with n=3 for the n-grams, up to 3 tokens can be included in an n-gram (e.g., as generated n-gram generator 224 as shown in FIG. 2). N-gram 420 can include, in this example, n-grams such as “Ebay”, “Marketplace”, “transaction”, “#123”, “BOS Ebay”, “BOS Ebay Marketplace” and so on.

Process 400 can receive dictionary 430 and retrieve for each n-gram, a list of probability values in dictionary 430. For example, dictionary 430 can be generated using model trainer 100 as discussed with respect to FIG. 1. In this example, given the n-gram “Ebay” in n-grams 420, the corresponding list of probability values can be retrieved for the n-gram “Ebay”. As depicted, the corresponding list of probability values can be [Ebay Mktplace: 0.1, Ebay: 0.15], which suggests that the n-gram “Ebay” alone can have a probability of 0.1 to mark the vendor as “Ebay Mktplace” in an arbitrary transaction and a probability of 0.15 to mark the vendor as “Ebay” in an arbitrary transaction, given the n-gram “Ebay” appears in the transaction. In other words, the lists of probability values can be regarded as conditional probabilities of respective vendors given the n-gram. Process 400 can iterate through all n-grams in n-grams 420 and retrieve the respective lists of probability values for the n-grams. In some examples, the retrieval is performed by score calculator 226 as discussed with respect to FIG. 2.

In addition, process 400 can compute, for each vendor, a vendor probability based on the retrieved lists of probability values. Process 400 can sum, for each vendor, the probability values associated with the vendor in the retrieved list of probability values. For example, the vendor “Ebay” is in the list [Ebay Mktplace: 0.1, Ebay: 0.15] associated with the n-gram “Ebay” and in the list [Amazon Mktplace: 0.05; Ebay: 0.05; Amazon: 0.03] associated with the n-gram “Marketplace”. Accordingly, the probability for “Ebay” to be the vendor associated with transaction data 410 is the sum of the probability values corresponding to the vendor “Ebay” in the two lists, which is p(Ebay|Ebay)+p(Ebay|Marketplace)=0.15+0.05=0.2. Accordingly, probabilities of other vendors associated with transaction data 410 can be calculated. The probabilities for all vendors associated with transaction data 410 can be compiled into a list of vendor probabilities 440. In some examples, the computation is performed by score calculator 226 as discussed with respect to FIG. 2.

In addition, process 400 can determine a recommended vendor based on the vendor probabilities 440. For example, a vendor with the maximum probability in vendor probabilities 440 can be determined as the recommended vendor. In this example, “Ebay” is the vendor with the maximum probability in vendor probabilities 440, and is determined as the recommended vendor. In some examples, the determination is performed by score calculator 226 as discussed with respect to FIG. 2.

### Example Operations for Recommending Vendors

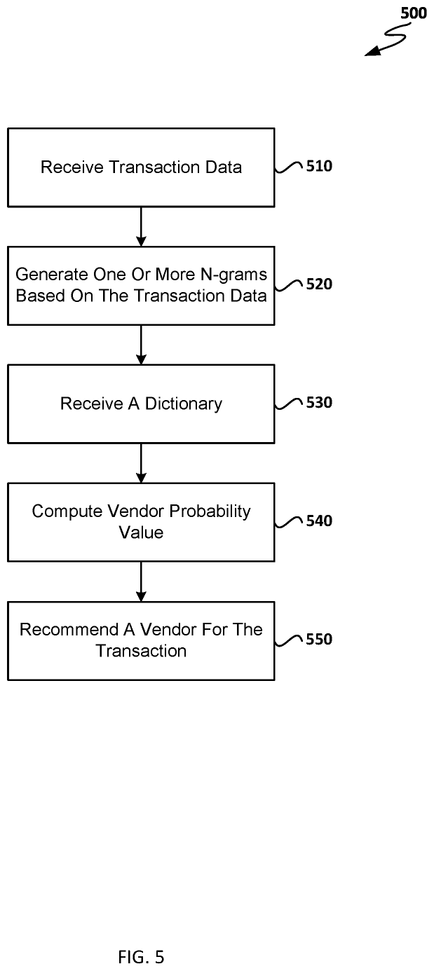

FIG. 5 is a flow diagram of example operations 500 for recommending vendors using machine learning models. Operations 500 may be performed by a predictive model, such as predictive model 200 as illustrated in FIG. 2.

Operations 500 begin at 510, where transaction data indicative of a transaction is received. Transaction data can be transaction data 210 as illustrated in FIG. 2.

At 520, one or more n-grams are generated based on the transaction data. For example, the one or more n-grams are generated using n-gram generator 224 as illustrated in FIG. 2. In some embodiments, the transaction data is split by spaces, added with a beginning of sentence (BOS) token at the beginning of the transaction data and an end of sentence (EOS) token at the end of the transaction data, and based on the splitting and the adding, used to determine a plurality of tokens of the transaction, wherein the one or more n-grams are generated based on the plurality of tokens. In some embodiments, the splitting and tokenization is performed by tokenizer 220, and optionally, (e.g., with generic tokens removed) by generic token remover 222 as shown in FIG. 2. In some embodiments, each n-gram of the one or more n-grams includes a maximum of 3 words (e.g., n has a maximum value of 3).

At 530, a dictionary is received, wherein the dictionary comprises one or more lists of probability values comprising, for each respective n-gram of the one or more n-grams, a respective list of probability values associated with the respective n-gram, wherein the one or more lists are based on occurrences of the one or more n-grams in a plurality of historical transactions associated with one or more vendors, wherein each list of the one or more lists comprises a plurality of probability values, and wherein each probability value in each list of the one or more lists is associated with a respective vendor of the one or more vendors. For example, the dictionary can be dictionary 212 as shown in FIG. 2.

At 540, a vendor probability value is computed for each respective vendor of the one or more vendors with respect to the transaction based on the one or more lists. For example, the computation can be performed by score calculator 226 as shown in FIG. 2. In some embodiments, probability values in the one or more lists of probability values associated with each n-gram of the one or more n-grams are summed to compute the vendor probability value, wherein the probability values are associated with the vendor. For example, the summation can be the summation used to generate vendor probabilities 440 as discussed with respect to FIG. 4.

At 550, a vendor is recommended for the transaction to a user based on the vendor probability value with respect to the transaction for each respective vendor of the one or more vendors. For example, the vendor recommended can be recommendation 230 as shown in FIG. 2. In some embodiments, that the recommended vendor does not have an exact vendor name match with the transaction is determined, and another vendor different from the recommended vendor is recommended based on using fuzzy string matching on the transaction. For example, another vendor recommended is generated using name matcher 228 as shown in FIG. 2.

### Example Application Server

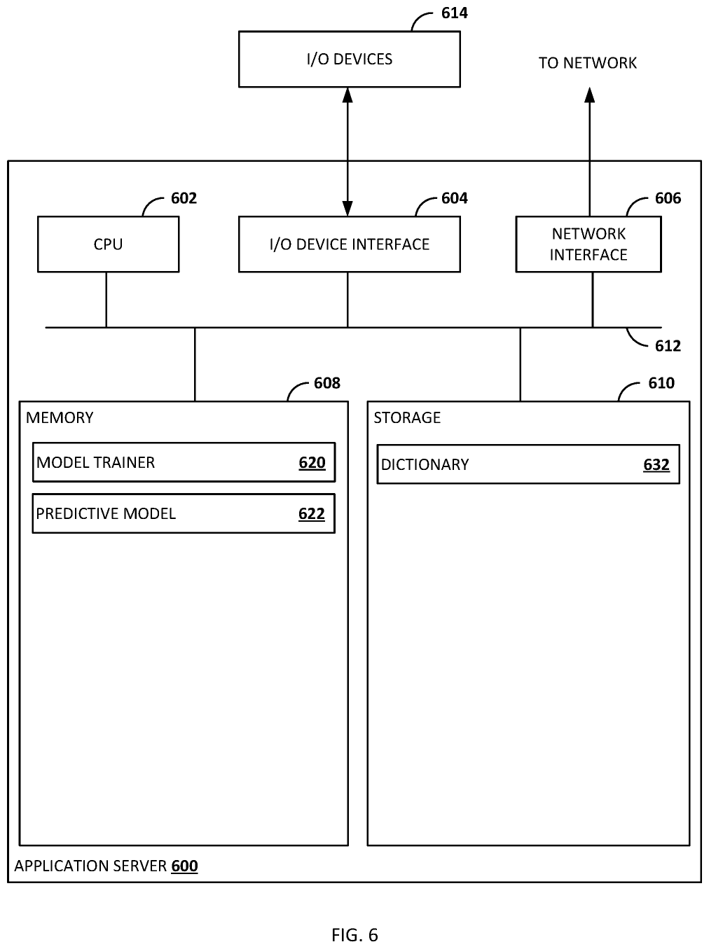

FIG. 6 depicts an example application server 600, which can be used to deploy model trainer 100 of FIG. 1 or predictive model 200 of FIG. 2. As shown, application server 600 includes a central processing unit (CPU) 602, one or more input/output (I/O) device interfaces 604, which may allow for the connection of various I/O devices 614 (e.g., keyboards, displays, mouse devices, pen input, etc.) to application server 600, a network interface 606, a memory 608, a storage 610, and an interconnect 612.

CPU 602 may retrieve and execute programming instructions stored in memory 608. Similarly, CPU 602 may retrieve and store application data residing in memory 608. Interconnect 612 transmits programming instructions and application data, among CPU 602, I/O device interface 604, network interface 606, memory 608, and storage 610. CPU 602 is included to be representative of a single CPU, multiple CPUs, a single CPU having multiple processing cores, and the like. I/O device interface 604 may provide an interface for capturing data from one or more input devices integrated into or connected to application server 600, such as keyboards, mice, touchscreens, and so on. Memory 608 may represent a random access memory (RAM), while storage 610 may be a solid state drive, for example. Although shown as a single unit, storage 610 may be a combination of fixed and/or removable storage devices, such as fixed drives, removable memory cards, network attached storage (NAS), or cloud-based storage. In some embodiments, storage 610 is an example of database 130 of FIG. 1.

As shown, memory 608 includes model trainer 620 and predictive model 622. Model trainer 620 and predictive model 622 may be the same as or substantially similar to model trainer 100 of FIG. 1 and predictive model 200 of FIG. 2, respectively.

As shown, storage 610 includes dictionary 632. Dictionary 632 may be the same as or substantially similar to dictionary 130 of FIG. 1, or dictionary 212 of FIG. 2.

It is noted that the components depicted in application server 600 are included as examples, and other types of computing components may be used to implement techniques described herein. For example, while memory 608 and storage 610 are depicted separately, components depicted within memory 608 and storage 610 may be stored in the same storage device or different storage devices associated with one or more computing devices.

### ADDITIONAL CONSIDERATIONS

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

1. A method, comprising:
receiving transaction data indicative of a transaction;
splitting the transaction data by spaces;
adding a beginning of sentence (BOS) token at a beginning of the transaction data and an end of sentence (EOS) token at an end of the transaction data;
determining a plurality of tokens of the transaction based on the splitting and the adding;
generating n-grams based on the plurality of tokens;
providing inputs to a machine learning model based on the n-grams, wherein pre-trained weights of the machine learning model are based on a dictionary that comprises one or more lists of probability values comprising, for each respective n-gram of the n-grams, a respective list of probability values associated with the respective n-gram, wherein:
the one or more lists are based on occurrences of the n-grams in a plurality of historical transactions associated with one or more vendors;
each list of the one or more lists comprises a plurality of probability values generated by normalizing frequencies with which particular n-grams of the n-grams are associated with particular vendors; and
each probability value in each list of the one or more lists is associated with a respective vendor of the one or more vendors;
determining, for each respective vendor of the one or more vendors, based on outputs received from the machine learning model in response to the inputs, a respective vendor probability value with respect to the transaction;
recommending a vendor for the transaction to a user based on the vendor probability value with respect to the transaction for each respective vendor of the one or more vendors;
receiving, in response to the recommending, user feedback accepting or rejecting the vendor for the transaction, wherein the machine learning model is re-trained based on the user feedback to produce a re-trained machine learning model;
using the re-trained machine learning model to determine a given vendor probability value for a given vendor with respect to a subsequent transaction; and
recommending the given vendor for the subsequent transaction based on the given vendor probability value.

2. The method of claim 1, further comprising:
determining that the recommended vendor does not have an exact vendor name match with the transaction; and
recommending another vendor different from the recommended vendor based on using fuzzy string matching on the transaction.

3. (canceled)

4. The method of claim 1, wherein each n-gram of the n-grams includes a maximum of 3 words.

5. The method of claim 1, wherein computing, for each vendor of the one or more vendors, a respective probability value with respect to the transaction, based on the one or more lists, comprises summing probability values in the one or more lists of probability values associated with each n-gram of the n-grams, wherein the probability values are associated with the vendor.

6-10. (canceled)

11. A system, comprising:
a memory including computer-executable instructions; and
a processor configured to execute the computer-executable instructions and cause the system to:
receive transaction data indicative of a transaction;
split the transaction data by spaces;
add a beginning of sentence (BOS) token at a beginning of the transaction data and an end of sentence (EOS) token at an end of the transaction data;
determine a plurality of tokens of the transaction based on the splitting and the adding;
generate n-grams based on the plurality of tokens;
provide inputs to a machine learning model based on the n-grams, wherein pre-trained weights of the machine learning model are based on a dictionary that comprises one or more lists of probability values comprising, for each respective n-gram of the n-grams, a respective list of probability values associated with the respective n-gram, wherein:
the one or more lists are based on occurrences of the n-grams in a plurality of historical transactions associated with one or more vendors;
each list of the one or more lists comprises a plurality of probability values generated by normalizing frequencies with which particular n-grams of the n-grams are associated with particular vendors; and
each probability value in each list of the one or more lists is associated with a respective vendor of the one or more vendors;
determine, for each respective vendor of the one or more vendors, based on outputs received from the machine learning model in response to the inputs, a respective vendor probability value with respect to the transaction;
recommend a vendor for the transaction to a user based on the vendor probability value with respect to the transaction for each respective vendor of the one or more vendors;
receive, in response to the recommending, user feedback accepting or rejecting the vendor for the transaction, wherein the machine learning model is re-trained based on the user feedback to produce a re-trained machine learning model;
use the re-trained machine learning model to determine a given vendor probability value for a given vendor with respect to a subsequent transaction; and
recommend the given vendor for the subsequent transaction based on the given vendor probability value.

12. The system of claim 11, wherein the processor is configured to execute the computer-executable instructions and cause the system to further:
determine that the recommended vendor does not have an exact vendor name match with the transaction; and
recommend another vendor different from the recommended vendor based on using fuzzy string matching on the transaction.

13. (canceled)

14. The system of claim 11, wherein each n-gram of the n-grams includes a maximum of 3 words.

15. The system of claim 11, wherein computing, for each vendor of the one or more vendors, a respective probability value with respect to the transaction, based on the one or more lists, comprises summing probability values in the one or more lists of probability values associated with each n-gram of the n-grams, wherein the probability values are associated with the vendor.

16-20. (canceled)

21. A non-transitory computer-readable medium comprising instructions that, when executed by one or more processors of a computing system, cause the computing system to:
receive transaction data indicative of a transaction;
split the transaction data by spaces;
add a beginning of sentence (BOS) token at a beginning of the transaction data and an end of sentence (EOS) token at an end of the transaction data;
determine a plurality of tokens of the transaction based on the splitting and the adding;
generate n-grams based on the plurality of tokens;
provide inputs to a machine learning model based on the n-grams, wherein pre-trained weights of the machine learning model are based on a dictionary that comprises one or more lists of probability values comprising, for each respective n-gram of the n-grams, a respective list of probability values associated with the respective n-gram, wherein:
the one or more lists are based on occurrences of the n-grams in a plurality of historical transactions associated with one or more vendors;
each list of the one or more lists comprises a plurality of probability values generated by normalizing frequencies with which particular n-grams of the n-grams are associated with particular vendors; and
each probability value in each list of the one or more lists is associated with a respective vendor of the one or more vendors;
determine, for each respective vendor of the one or more vendors, based on outputs received from the machine learning model in response to the inputs, a respective vendor probability value with respect to the transaction;
recommend a vendor for the transaction to a user based on the vendor probability value with respect to the transaction for each respective vendor of the one or more vendors;
receive, in response to the recommending, user feedback accepting or rejecting the vendor for the transaction, wherein the machine learning model is re-trained based on the user feedback to produce a re-trained machine learning model;
use the re-trained machine learning model to determine a given vendor probability value for a given vendor with respect to a subsequent transaction; and
recommend the given vendor for the subsequent transaction based on the given vendor probability value.

22. The non-transitory computer-readable medium of claim 21, wherein the instructions, when executed by the one or more processors, further cause the computing system to:
determine that the recommended vendor does not have an exact vendor name match with the transaction; and
recommend another vendor different from the recommended vendor based on using fuzzy string matching on the transaction.

23. (canceled)

24. The non-transitory computer-readable medium of claim 21, wherein each n-gram of the n-grams includes a maximum of 3 words.

25. The non-transitory computer-readable medium of claim 21, wherein computing, for each vendor of the one or more vendors, a respective probability value with respect to the transaction, based on the one or more lists, comprises summing probability values in the one or more lists of probability values associated with each n-gram of the n-grams, wherein the probability values are associated with the vendor.
